(19) United States
(12) Patent Application Publication
(10) Pub. No.: US 2022/0398492 A1
(43) Pub. Date: Dec. 15, 2022

(54) METHOD OF TIME SERIES PREDICTION AND SYSTEM THEREOF

(71) Applicant: Aiola Ltd., Herzeliya (IL)

(72) Inventors: Aviv NAVON, Kiryat Tiv'on (IL); Eyal GAL, Kefar Sava (IL); Guy ERNEST, Netanya (IL); Oren BEN MEIR, Pardesiya (IL)

(21) Appl. No.: 17/347,960

(22) Filed: Jun. 15, 2021

(51) Int. Cl. G06N 20/00; G06K 9/62; G06K 9/00

(52) U.S. Cl. CPC G06N 20/00; G06K 9/6256; G06K 9/6262; G06K 9/6221; G06K 9/00523

(57) ABSTRACT

There is provided a system and method of time series (TS) prediction. The method includes providing a machine learning (ML) network trained to perform TS prediction with respect to one or more components, the ML network configured with a set of hyperparameters including one or more hyperparameters associated with each component, the ML network comprising one or more ML modules operatively connected to an output layer, each ML module configured to represent a respective component in accordance with a given model characterized by the one or more hyperparameters associated therewith, where values of the hyperparameters associated with each component are automatically optimized during training of the ML network; and in response to a user's request for TS prediction, using the trained ML network to perform TS prediction, giving rise to a prediction result comprising an overall predicted TS, and one or more decomposed TS corresponding to respective components.

### TECHNICAL FIELD

The presently disclosed subject matter relates, in general, to the field of data prediction, and more specifically, to machine learning based time series (TS) prediction (forecasting).

### BACKGROUND

With rapid development of industrial processes and computerization, enterprises and organizations are constantly facing challenges with respect to data management and analysis. In today's digital economy, it is recognized that enterprises rely on their timely performance information to support strategic planning and decision making. Enterprises must become data-driven in order to improve business performance, create sustainable value for customers, and deliver unprecedented levels of services to remain competitive.

Machine learning technology has been recently employed to analyze enterprise data and predict likely outcomes, which may benefit organizations by automating the processes, making data-driven decisions, and improving the efficiency and accuracy of organizational operations. However, current machine learning based systems have various limitations, such as, e.g., shortage and noisiness of training data, configuration and computation complexity, limitation of transparency and explainability, etc.

Accordingly, it may be desirable to have an improved data prediction system that can accurately predict future data related to various business/organizational aspects based on historical data that have been monitored over time. In some cases, certain enterprise data can be represented in the form of time series, e.g., as a sequence of observations taken sequentially in time. Time series analysis is useful for extracting meaningful statistics and characteristics of the data and inspecting how they change over time. Time series forecasting can be used to predict future values based on previously observed values, thereby allowing improved planning and resources allocations.

### SUMMARY

In accordance with certain aspects of the presently disclosed subject matter, there is provided a computerized method of time series (TS) prediction, comprising: providing a machine learning (ML) network trained to perform TS prediction with respect to one or more components each representing an underlying pattern indicative of a specific type of behavior of a time series, wherein the ML network is configured with a set of hyperparameters including one or more hyperparameters associated with each component, the ML network comprising one or more ML modules operatively connected to an output layer, wherein each ML module is configured to represent a respective component in accordance with a given model thereof, the given model characterized by the one or more hyperparameters associated with the respective component, wherein values of the one or more hyperparameters associated with each component are automatically optimized during training of the ML network; and in response to a user's request for TS prediction for a given time period, using the trained ML network to perform TS prediction, giving rise to a prediction result comprising an overall predicted TS, as an overall output of the output layer, and one or more decomposed TS of the overall predicted TS, as output of the one or more ML modules, each decomposed TS representative of a partial prediction of the given time period corresponding to a respective component represented by the corresponding ML module.

In addition to the above features, the method according to this aspect of the presently disclosed subject matter can comprise one or more of features (i) to (xiv) listed below, in any desired combination or permutation which is technically possible:
(i). The one or more components are selected from a group comprising: trend, seasonality, events, autoregressive, and external regressor.
(ii). The one or more ML modules comprise a first ML module configured to represent a component of trend in accordance with a spline function indicative of changes of trend.
(iii). The one or more hyperparameters characterizing the spline function include changing time points between neighboring pieces of the spline function, and a gradient of each piece of the spline function.
(iv). The one or more ML modules comprise a second ML module configured to represent a component of seasonality in accordance with one or more periodic functions indicative of seasonal changes.
(v). The one or more hyperparameters characterizing the periodic functions include the periodicity of each periodic function.
(vi). The one or more ML modules comprise a third ML module configured to represent special events in accordance with one or more pulse functions indicative of irregular events.
(vii). The one or more hyperparameters characterizing the pulse functions include a time window of each pulse function.
(viii). The ML network is trained using training data including historical TS data pertaining to one or more tasks, to jointly optimize values of network parameters and the set of hyperparameters.
(ix). The one or more tasks comprise multiple tasks that are correlated to each other, and the multiple tasks are selected using unsupervised learning by grouping tasks that share similar feature representation in a multi-dimensional feature space.
(x). The prediction result further comprises the values of the set of hyperparameters of the trained ML network.
(xi). The method further comprises receiving updated TS data pertaining to at least one component in runtime, and using the updated TS data as additional training data to retrain the ML network, before using the ML network to perform TS prediction.
(xii). The method further comprises, upon receiving the user's feedback with respect to at least one decomposed TS corresponding to at least one component, updating the one or more hyperparameters associated with the at least one component based on the feedback; re-training the ML network using the set of hyperparameters including the updated hyperparameters, giving rise to a re-trained ML network; and using the re-trained ML network to generate an updated prediction result to be sent to the user.
(xiii). The method further comprises, upon receiving the user's feedback on the prediction result indicating one or more additional hyperparameters to be associated with at least one existing component and/or associated with at least one additional component, modifying at least one ML module representing the at least one component, or adding at least an additional ML module representing the at least one additional component to reflect the additional hyperparameters; re-training the ML network using the set of hyperparameters including the additional hyperparameters, giving rise to a re-trained ML network, and using the re-trained ML network to generate an updated prediction result to be sent to the user.
(xiv). Each of the one or more ML modules is implemented in a form selected from a group comprising: support vector machine, decision tree, neural network, genetic model, or a combination thereof.

In accordance with other aspects of the presently disclosed subject matter, there is provided a system of time series (TS) prediction, the system comprising a processor and memory circuitry (PMC) configured to: provide a machine learning (ML) network trained to perform TS prediction with respect to one or more components each representing an underlying pattern indicative of a specific type of behavior of a time series, wherein the ML network is configured with a set of hyperparameters including one or more hyperparameters associated with each component, the ML network comprising one or more ML modules operatively connected to an output layer, wherein each ML module is configured to represent a respective component in accordance with a given model thereof, the given model characterized by the one or more hyperparameters associated with the respective component, wherein values of the one or more hyperparameters associated with each component are automatically optimized during training of the ML network; and in response to a user's request of TS prediction for a given time period, use the trained ML network to perform TS prediction, giving rise to a prediction result comprising an overall predicted TS, as an overall output of the output layer, and one or more decomposed TS of the overall predicted TS, as output of the one or more ML modules, each decomposed TS representative of a partial prediction of the given time period corresponding to a respective component represented by the corresponding ML module.

This aspect of the disclosed subject matter can comprise one or more of features (i) to (xiv) listed above with respect to the method, mutatis mutandis, in any desired combination or permutation which is technically possible.

In accordance with other aspects of the presently disclosed subject matter, there is provided a non-transitory computer readable medium comprising instructions that, when executed by a computer, cause the computer to perform a method of time series (TS) prediction, the method comprising: providing a machine learning (ML) network trained to perform TS prediction with respect to one or more components each representing an underlying pattern indicative of a specific type of behavior of a time series, wherein the ML network is configured with a set of hyperparameters including one or more hyperparameters associated with each component, the ML network comprising one or more ML modules operatively connected to an output layer, wherein each ML module is configured to represent a respective component in accordance with a given model thereof, the given model characterized by the one or more hyperparameters associated with the respective component, wherein values of the one or more hyperparameters associated with each component are automatically optimized during training of the ML network; and in response to a user's request for TS prediction for a given time period, using the trained ML network to perform TS prediction, giving rise to a prediction result comprising an overall predicted TS, as an overall output of the output layer, and one or more decomposed TS of the overall predicted TS, as output of the one or more ML modules, each decomposed TS representative of a partial prediction of the given time period corresponding to a respective component represented by the corresponding ML module.

This aspect of the disclosed subject matter can comprise one or more of features (i) to (xiv) listed above with respect to the method, mutatis mutandis, in any desired combination or permutation which is technically possible.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1A illustrates a functional block diagram of a time series (TS) prediction system in accordance with certain embodiments of the presently disclosed subject matter.

FIG. 1B illustrates a schematic functional block diagram of an exemplified machine learning network 106 in accordance with certain embodiments of the presently disclosed subject matter.

FIG. 2 illustrates a generalized flowchart of TS prediction in accordance with certain embodiments of the presently disclosed subject matter.

FIG. 3 illustrates a generalized flowchart of training the ML network in accordance with certain embodiments of the presently disclosed subject matter.

FIG. 4 illustrates a generalized flowchart of a runtime retraining process of the ML network based on updated TS data in accordance with certain embodiments of the presently disclosed subject matter.

FIG. 5 illustrates a generalized flowchart of a runtime retraining process of the ML network based on user feedback in accordance with certain embodiments of the presently disclosed subject matter.

FIG. 6 illustrates an example of multi-task learning in accordance with certain embodiments of the presently disclosed subject matter.

FIG. 7 illustrates examples of an overall predicted time series in accordance with certain embodiments of the presently disclosed subject matter.

FIG. 8 illustrates an example of decomposed TSs of an overall TS in accordance with certain embodiments of the presently disclosed subject matter.

### DETAILED DESCRIPTION OF EMBODIMENTS

In the following detailed description, numerous specific details are set forth in order to provide a thorough understanding of the disclosure. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “providing”, “using”, “generating”, “training”, “optimizing”, “selecting”, “updating”, “re-training”, “grouping”, “performing”, “receiving”, “modifying”, “adding, “predicting”, “forecasting” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the system of time series prediction and respective parts thereof disclosed in the present application.

The terms “non-transitory computer-readable memory” and “non-transitory computer-readable storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

Embodiments of the presently disclosed subject matter are not described with reference to any particular programming language. It will be appreciated that a variety of programming languages may be used to implement the teachings of the presently disclosed subject matter as described herein.

As used herein, the phrase “for example,” “such as”, “for instance” and variants thereof describe non-limiting embodiments of the presently disclosed subject matter. Reference in the specification to “one case”, “some cases”. “other cases” or variants thereof means that a particular feature, structure or characteristic described in connection with the embodiment(s) is included in at least one embodiment of the presently disclosed subject matter. Thus the appearance of the phrase “one case”, “some cases”. “other cases” or variants thereof does not necessarily refer to the same embodiment(s).

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

In embodiments of the presently disclosed subject matter, one or more stages illustrated in the figures may be executed in a different order and/or one or more groups of stages may be executed simultaneously, and vice versa.

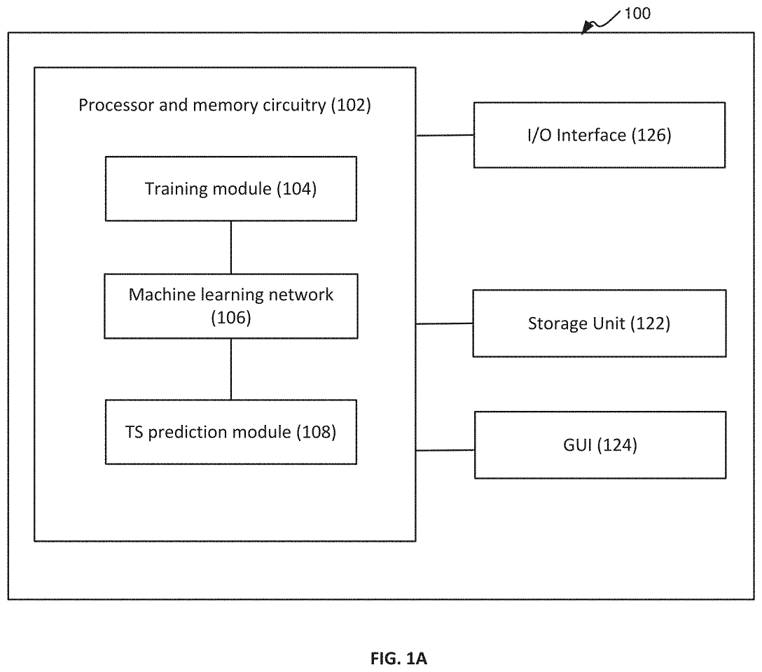

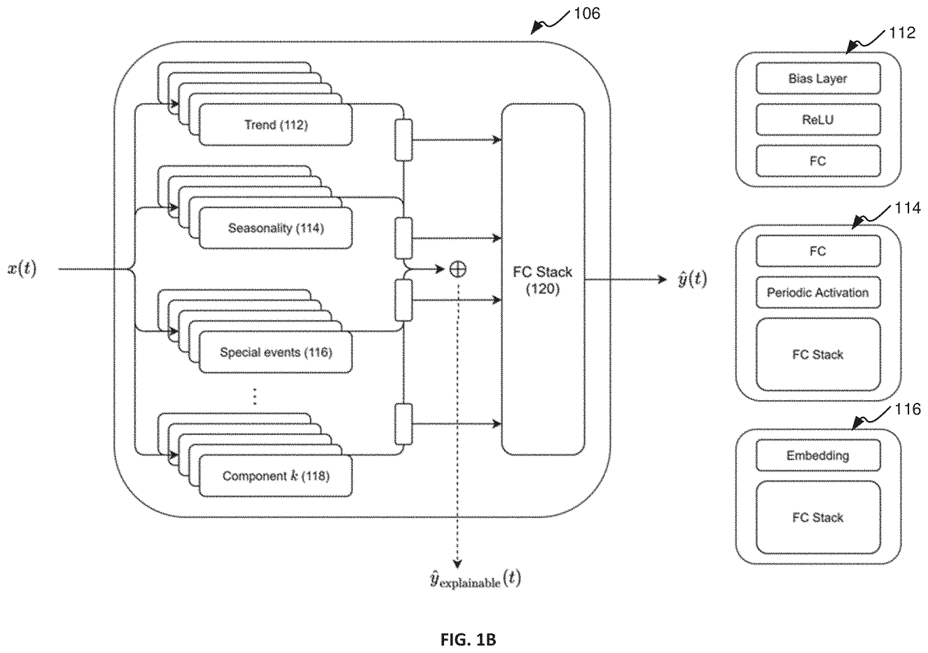

Bearing this in mind, attention is drawn to FIG. 1 illustrating a functional block diagram of a time series (TS) prediction system in accordance with certain embodiments of the presently disclosed subject matter.

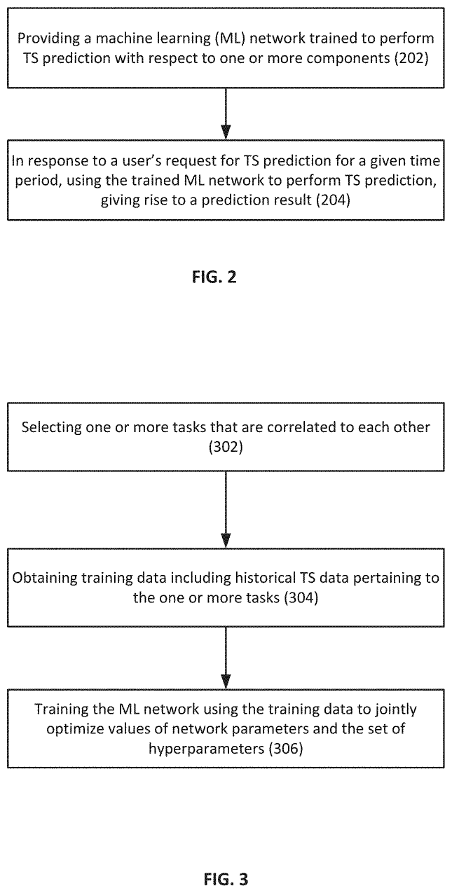

The system 100 illustrated in FIG. 1 is a computer-based system that can be used for TS prediction related to prediction tasks with respect to an organization, a specific field/subject, etc. According to certain embodiments of the presently disclosed subject matter, the system 100 can be configured to perform time series prediction based on machine learning technology, as will be described below in further detail with reference to FIGS. 2-5. System 100 is thus also referred to as a TS prediction system or a prediction system in the present disclosure.

In some embodiments, system 100 can be operatively connected to one or more data management systems (not shown in FIG. 1). The term “data management system” referred to herein should be expansively construed to cover any enterprise management system(s) (e.g., enterprise resource planning (ERP), customer relationship management (CRM), etc.) and/or an internal database of such systems which are configured to store and manage raw data and/or structured data related to organizational entities. In some embodiments, the system 100 can be further operatively connected to external data repositories for storing and providing necessary data.

The term “time series” referred to herein should be expansively construed to cover any sequence of observations taken at successive spaced points in time. Organization data, when represented and analyzed in the form of time series, can reflect meaningful statistics and characteristics of the data and indicate how certain variables or properties change over time. In particular, time series prediction, also termed as time series forecasting, can refer to creating a machine learning model fit on historical data (e.g., previously observed values) and use the model to predict future observations. It is to be noted that in some cases certain data sequence of observations can be taken over other domains/dimensions other than time, such as, e.g., wave height over geographical range, etc. Such data sequences can be first transformed into time series data, upon which the presently disclosed method for prediction can be applied.

Typically time series data can be regarded as constituting one or more components each representing one of the underlying aspects of patterns which is indicative of a specific characteristic or type of behavior of the time series. It can also be understood that the components of time series data change over time under the influence of certain real-life factors that affect the behaviors thereof. The components or component series can be combined to reconstruct the overall time series by any suitable aggregation methods, such as e.g., additions, multiplications, weighted average, etc. Details of the components will be described below in detail with reference to FIG. 2.

Time series forecasting generally requires a set of hyperparameters (also referred to as hyper-parameters) of the model to be selected and tuned. In machine learning, a hyperparameter generally refers to a parameter of the model whose value is predefined as being related to the learning process (e.g., the number of nodes in a neural network), as compared to the other parameters whose values are derived via training (e.g., weights of nodes and/or edges in the neural network). Hyperparameters conventionally cannot be inferred while fitting the model to the training set because they relate to the model or algorithm selection task, yet they have strong influence on the performance of the model, and affect the speed and quality of the learning process. An example of a conventional model hyperparameter can be the topology, layer, learning rate, and batch size of a neural network. Such hyperparameters are sometimes also referred to as configuration parameters of a ML model.

According to certain embodiments, the hyperparameters referred to herein with respect to TS prediction refer to component hyperparameters which are specifically associated with the TS components of a time series (as will be detailed below) and representative of how real-life factors affecting the prediction of the specific components (thus the terms hyperparameter and component hyperparameter are used exchangeably throughout the present disclosure). For example, the seasonality component is associated with a component hyperparameter representative of the periods (cycles) contained in the TS data. In another example, the special event component is associated with a component hyperparameter representative of an expected effect window of each event. Selection and/or tuning of the values for such hyperparameters is normally performed manually, thus rely heavily on domain expertise or heuristics. In some cases, the manual tuning of the hyperparameter values may require several iterations of training of the ML model, thus can be time-consuming, inefficient, and may lead to sub-optimal results.

According to certain embodiments of the presently disclosed subject matter, the proposed TS prediction system is specifically designed and configured to automate the selection of hyperparameter values thereof, which not only saves computational time and resources, but also results in more precise values for these parameters. In some cases, the automation can also enable the system to have a significantly higher number of hyperparameters as compared to when the hyperparameters were manually tuned. The proposed TS prediction system has improved forecasting performance with higher accuracy and lower error rate.

Prediction system 100 includes a processor and memory circuitry (PMC) 102 operatively connected to a hardware-based I/O interface 126. PMC 102 is configured to provide all processing necessary for operating the system 100 as further detailed with reference to FIG. 2 and comprises a processor (not shown separately in FIG. 1) and a memory (not shown separately in FIG. 1). The processor of PMC 102 can be configured to execute several functional modules in accordance with computer-readable instructions implemented on a non-transitory computer-readable memory or storage medium comprised in the PMC. Such functional modules are referred to hereinafter as comprised in the PMC.

The processor referred to herein can represent one or more general-purpose processing devices such as a microprocessor, a central processing unit, or the like. More particularly, the processor may be a complex instruction set computing (CISC) microprocessor, a reduced instruction set computing (RISC) microprocessor, a very long instruction word (VLIW) microprocessor, or a processor implementing other instruction sets, or processors implementing a combination of instruction sets. The processor may also be one or more special-purpose processing devices such as an application specific integrated circuit (ASIC), a field programmable gate array (FPGA), a digital signal processor (DSP), a network processor, or the like. The processor is configured to execute instructions for performing the operations and steps discussed herein.

The memory referred to herein can comprise a main memory (e.g., read-only memory (ROM), flash memory, dynamic random access memory (DRAM) such as synchronous DRAM (SDRAM) or Rambus DRAM (RDRAM), etc.), and a static memory (e.g., flash memory, static random access memory (SRAM), etc.).

In certain embodiments, functional modules comprised in PMC 102 can include a training module 104, a machine learning module 106, a TS prediction module 108 which are operatively connected therebetween. The PMC 102 can be configured to provide a machine learning (ML) network 106 trained to perform time series prediction with respect to one or more components of the time series. The ML network is configured with a set of hyperparameters including one or more hyperparameters associated with each component. The ML network comprises one or more ML modules operatively connected to an output layer. Each ML module is configured to represent a respective component in accordance with a given model thereof, the given model characterized by the one or more hyperparameters associated with the respective component. The values of the one or more hyperparameters associated with each component are automatically tuned/optimized during training of the ML network. e.g., by the training module 104. Details of the ML network structure are described below with reference to FIG. 1B.

In inference stage/phase (also referred to as prediction phase, runtime phase, etc.), in response to a user's request of TS prediction for a given time period, the TS prediction module 108 can be configured to use the trained ML network to perform TS prediction, giving rise to a prediction result comprising an overall predicted TS, as an overall output of the output layer, and one or more decomposed TS of the overall predicted TS, as output of the one or more ML modules. Each decomposed TS is representative of a partial prediction of the given time period corresponding to a respective component represented by the corresponding ML module.

Operation of system 100, PMC 102 and the functional modules therein will be further detailed with reference to FIGS. 2-5.

Turning now to FIG. 1B, there is illustrated a schematic functional block diagram of an exemplified machine learning network 106 in accordance with certain embodiments of the presently disclosed subject matter.

As exemplified in FIG. 1B, the ML network 106 comprises a plurality of ML modules, such as, e.g., a first ML module 112 representative of a component of trend, a second ML module 114 representative of a component of seasonality, and a third ML module 116 representative of a component of special events (also referred to as events), etc. In some embodiments, the ML network can include one or more additional ML modules 118 representative of additional components. Each ML module is configured in accordance with a given model (e.g., a mathematical model) of the represented component. The given model is characterized by the one or more hyperparameters associated with the represented component. The plurality of ML modules are operatively connected to an output layer 120 which is configured to combine the outputs from the ML modules and provide an overall prediction result. The structure of the ML modules, as well as the output layer, will be detailed below with respect to FIG. 2.

According to certain embodiments, the ML network 106 referred to herein, as well as the ML modules 112, 114, 116 and 118 as comprised therein, can be implemented as various types of machine learning models, such as, e.g., support vector machines, decision trees, neural networks, genetic models, or ensembles/combinations thereof etc. The learning algorithm used by the ML model can be any of the following: supervised learning, unsupervised learning, or semi-supervised learning, etc. The presently disclosed subject matter is not limited to the specific type or learning algorithm used by the ML model.

In some embodiments, the ML network 106 can be implemented as a deep neural network (DNN) which includes layers organized in accordance with respective DNN architecture. By way of non-limiting example, the layers of DNN can be organized in accordance with Convolutional Neural Network (CNN) architecture, Recurrent Neural Network architecture, Recursive Neural Networks architecture, Generative Adversarial Network (GAN) architecture, or otherwise. In some embodiments, at least some of the ML modules 112, 114, 116 and 118 comprised therein can be organized and implemented as DNN sub-networks.

Each layer of the DNN can include multiple basic computational elements (CE) typically referred to in the art as dimensions, neurons, or nodes. Generally, CEs of a given layer can be connected with CEs of a preceding layer and/or a subsequent layer. Each connection between the CE of a preceding layer and the CE of a subsequent layer is associated with a weighting value. A given CE can receive inputs from CEs of a previous layer via the respective connections, each given connection being associated with a weighting value which can be applied to the input of the given connection. The weighting values can determine the relative strength of the connections and thus the relative influence of the respective inputs on the output of the given CE. The given CE can be configured to compute an activation value (e.g. the weighted sum of the inputs) and further derive an output by applying an activation function to the computed activation. The activation function can be, for example, an identity function, a deterministic function (e.g., linear, sigmoid, threshold, or the like), a stochastic function, or other suitable function. The output from the given CE can be transmitted to CEs of a subsequent layer via the respective connections. Likewise, as above, each connection at the output of a CE can be associated with a weighting value which can be applied to the output of the CE prior to being received as an input of a CE of a subsequent layer. Further to the weighting values, there can be threshold values (including limiting functions) associated with the connections and CEs.

The ML network (e.g., the DNN) has a set of network parameters (such as, e.g., the weighting and/or threshold values of the DNN) that are calculated as part of the training phase. The initial values of the network parameters of a DNN can be selected prior to training, and can be further iteratively adjusted or modified during training to achieve an optimal set of weighting and/or threshold values in a trained DNN. After each iteration, a difference can be determined between the actual output produced by DNN and the target output associated with the respective training set of data. The difference can be referred to as an error value. Training can be determined to be complete when a cost function indicative of the error value is less than a predetermined value, or when a limited change in performance between iterations is achieved.

A set of DNN input data used to adjust the network parameters of a deep neural network is referred to hereinafter as a training set, or training dataset, or training data. As aforementioned, the training of the ML network, as well as the ML modules, can be performed by the training module 104 during the training phase, as will be detailed below with reference to FIG. 3.

According to certain embodiments, at least some of the ML modules (e.g., DNN sub-networks) can be simultaneously trained w % ben training the entire DNN. In some other cases, alternatively, the ML modules can be trained separately prior to training the entire DNN.

As described above, the ML network is configured with a set of hyperparameters. Specifically, each ML module in the ML network is configured with one or more hyperparameters associated with the respective component. Such hyperparameters which were previously predetermined manually before the training phase, are now automatically tuned and optimized during training of the ML network, as will be described below in further detail.

It is noted that the above described DNN architecture is for exemplary purposes only and is only one possible way of implementing the ML network, and the teachings of the presently disclosed subject matter are not bound by the specific model and architecture as described above.

According to certain embodiments, system 100 can comprise a storage unit 122. The storage unit 122 can be configured to store any data necessary for operating system 100, e.g., data related to input and output of system 100, as well as intermediate processing results generated by system 100. By way of example, the storage unit 122 can be configured to store the training data, the ML network and modules thereof, the prediction result, etc. Accordingly, necessary data and/or models can be retrieved from the storage unit 122 and provided to the PMC 102 for further processing. Alternatively, these data can be stored in a different system (e.g., the enterprise management system) or data repository (which may be located either locally or remotely) that are operatively connected to system 100, and can be retrieved by system 100 through an I/O interface 126.

In some embodiments, system 100 can optionally comprise a computer-based graphical user interface (GUI) 124 which is configured to enable user-specified inputs related to system 100. The user may be provided, through the GUI, with options of defining certain operation parameters. For instance, in some cases, the user can be presented with an interface to provide a request of TS prediction. The user may also view the prediction results, such as, e.g., the overall predicted TS, and the decomposed predicted TS, on the GUI, and can provide feedback on the prediction result through the GUI. The prediction result can also be sent, through the I/O interface 126, to a different system (e.g., the enterprise management system) or data repository that are operatively connected to the system 100 for further rendering.

Those versed in the art will readily appreciate that the teachings of the presently disclosed subject matter are not bound by the system illustrated in FIGS. 1A and 1B; equivalent and/or modified functionality can be consolidated or divided in another manner and can be implemented in any appropriate combination of software with firmware and/or hardware.

It is noted that the system 100 illustrated in FIGS. 1A and 1B can be implemented in a distributed computing environment, in which the aforementioned functional modules shown in FIGS. 1A and 1B can be distributed over several local and/or remote devices, and can be linked through a communication network. For instance, the training module 104 and the prediction module 108 can be located at different places/entities. It is further noted that in another embodiment, at least part of the ML network 106, storage unit 122 and/or GUI 124 can be external to the system 100 and operate in data communication with system 100 via I/O interface 126. By way of example, the ML network, and/or some of the ML modules thereof, can be pre-trained and stored externally and can be obtained and processed by system 100 via I/O interface 126. Alternatively, the respective functions of the ML modules can, at least partly, be integrated with system 100, thereby facilitating and enhancing the functionalities of the system. By way of another example, the data repositories or the storage unit therein can be shared with other systems or be provided by other systems, including third party equipment.

It is noted that the presently disclosed prediction system 100 can be implemented in a computer or a computerized machine within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in a client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is described, the term “machine” shall also be taken to include any collection of machines that individually or jointly execute a set (or multiple sets) of instructions to perform any one or more of the methodologies discussed herein.

While not necessarily so, the process of operation of system 100 can correspond to some or all of the stages of the methods described with respect to FIGS. 2-5. Likewise, the methods described with respect to FIGS. 2-5 and their possible implementations can be implemented by system 100. It is therefore noted that embodiments discussed in relation to the methods described with respect to FIGS. 2-5 can also be implemented, mutatis mutandis as various embodiments of the system 100, and vice versa.

Referring to FIG. 2, there is illustrated a generalized flowchart of TS prediction in accordance with certain embodiments of the presently disclosed subject matter.

A machine learning (ML) network can be provided (e.g., by the PMC 102 of system 100). The ML network is trained (e.g., by the training module 104) to perform time series prediction with respect to one or more components of the time series. Time series can refer to a sequence of observations of a specific field/subject related to an entity, such as, e.g., an organization, an enterprise, a company, an institute, an industry, a country, etc. In one example, a time series can represent daily product sales for a specific retail store in the last six months. In another example, a time series can represent the weekly average price of gasoline in a city in the past year. In a further example, a time series can represent the yearly crop yield or steel production of a country in the past twenty years. The present disclosure should not be limited to time series related to any specific subject and/or specific entity. By way of example, the entity can be a company, and the specific subject related thereto can be selected from a group comprising: production, sales, pricing, planning, distribution, etc.

As described above, the one or more components of a time series represent the underlying categories of patterns which are indicative of specific characteristics or types of behaviors of the time series. According to certain embodiments, the one or more components can be selected from a group comprising the following components: trend, seasonality, special events, autoregressive, and external regressor, etc.

The trend component reflects a relatively long-term progression of the time series. A trend exists when there is a persistent increasing or decreasing direction in the time series data. The increasing or decreasing of the trend component can be in a linear or a non-linear form. The seasonality component reflects seasonal variation of patterns when a time series is influenced by seasonal factors. Seasonality usually reflects a periodic change and occurs over a fixed and known period (e.g., a day, a week, a month, or a quarter of the year, etc.). The special event component reflects random, irregular variation of the data due to irregular events which are usually non-periodic, such as, e.g., holidays, promotions, etc. The autoregressive component represents the effect of recent historical observations of the series or related TS on the current time point of the time series. The external regressor component represents the effect of additional external factors. For example, when forecasting the demand for a certain product, the impact of external factors such as the product's price, information on competitors, etc. can be modelled.

The specific components as represented by the ML network can be selected from the above list in any number and combination thereof, and, in some cases, can comprise additional components which are not specified herein. As exemplified in FIG. 1B, three components of trend, seasonality and special events are specified to be included in the ML network. However, this is only for illustrative purposes and should by no means be regarded as limiting the present disclosure in any way. Any other component can be included in addition to or in lieu of the above component(s). According to some embodiments, the components of the time series can be combined to reconstruct the overall time series, and the combination can be done by any suitable aggregation methods, such as, e.g., additions, multiplications, weighted average, etc.

As described above, conventionally each of the above components may have associated hyperparameters that require manual selection and tuning, which traditionally heavily relies upon domain expertise. For example, the seasonality component requires one to select the periods (cycles) contained in the data. In another example, the special event component requires one to pre-specify the events and the expected effect window of each event. When working at scale and with multiple time-series, this parameter selection requires a significant amount of time of domain experts. In addition, even if one invests the time and effort to specify and tune these parameters, it is highly likely that the manual selection and tuning will result in a sub-optimal result, as the nature of the underlying model may be more complex, e.g., with various unknown seasonality related factors. Thus, manual tuning may be time-consuming and result in an underspecified model with suboptimal performance.

For addressing the above issues, certain embodiments of the present disclosure propose to view the hyperparameters as trainable parameters and optimize them jointly with the network parameters of the ML network. The ML network is specifically designed and constructed to model the components so as to be able to train the hyperparameters as part of the training of the ML network, as detailed below.

According to certain embodiments, the ML network for performing time series prediction is configured with a set of hyperparameters including one or more hyperparameters associated with each component of the one or more components represented in the ML network. As described above, the ML network comprises one or more ML modules operatively connected to an output layer. Each ML module is configured to represent a respective component in accordance with a given model thereof. Specifically, the given model is characterized by the one or more hyperparameters associated with the respective component. By way of example, the model can be a mathematical model representing specific underlying characteristics or behaviors of the component.

According to certain embodiments, the one or more ML modules can comprise a first ML module configured to represent a component of trend (i.e., trend component) in accordance with a given model thereof. By way of example, the model of the trend component can be a spline function indicative of changes of the trend. The spline function refers to a piecewise polynomial function that is defined by multiple sub-functions where each sub-function is a polynomial function applied to a respective time interval. In some embodiments, the one or more hyperparameters characterizing the spline function can include the turning/changing time points between neighboring pieces of the spline function, and the slope (e.g., gradient) of each piece of the function.

By way of example, the spline function can be represented by the below piecewise linear equation, where g(t) provides a corresponding value for a given input time t, H(t) represents a step function, such as, e.g., Heaviside step function, and aₖ is the associated weight or coefficient thereof:

$$g ( t ) = {\sum }_{k} {a}_{κ} tH ( t - {∅}_{k} )$$

Heaviside step function is one kind of activation function (i.e., a unit that is responsible for transforming the summed weighted input from a neural node into the activation of the node or output for that input) used in neural networks. The Heaviside step function produces a binary output, thus is also referred to as a binary step function. Specifically, the function produces 1 (or true) when the input passes a threshold limit whereas it produces 0 (or false) when the input does not pass the threshold limit.

The above mathematical model/function can be implemented by the corresponding ML module. For instance, as exemplified in FIG. 1B, the ML module 112 illustrated on the right side of the figure is specifically constructed to represent the above function. For instance, the ML module 112 can comprise three layers: a bias layer, a Rectified Linear Unit (ReLU) layer, and an output fully connected (FC) layer. The bias layer applies a bias Øₖ to the input time t and provides an output of t−Øₖ. The ReLU layer implements a rectified linear activation function which is a piecewise linear function that will output the input directly if it is positive, and output zero otherwise. Thus the ReLU layer will zero out the output for input time t′<Øₖ. Therefore, the output of this layer is a certain constant for t<Øₖ and a linear function for t>=Øₖ. As the ReLU layer implements a k-piece piecewise linear function, the FC layer will connect the output of different pieces of functions together to provide an overall output. By way of example, the one or more hyperparameters characterizing the function can include the turning/changing time points between different pieces (e.g., Øₖ).

According to certain embodiments, the one or more ML modules can comprise a second ML module configured to represent a component of seasonality (i.e., seasonality component) in accordance with one or more periodic functions indicative of seasonal changes. By way of example, the periodic functions refer to functions that repeat their values at regular intervals, for example, the trigonometric functions, such as the sine, the cosine, and the tangent functions, etc. The seasonal changes can be periodic, such as, e.g., weekly, monthly, yearly, etc. In some embodiments, the one or more hyperparameters characterizing the periodic functions include the periodicity of each periodic function.

By way of example, the periodic functions can be represented by the below equation, where s(t) provides a corresponding value for a given input time t, and E(t) represents a periodic function with respect to a sine function and a cosine function (such a function E(t) can be regarded as one periodic function, or multiple periodic functions), and P refers to the periodicity of the function.

$$s ( t ) = ∅ ( E ( t ) ) , {E}_{kp} ( t ) = ( cos ( \frac{2 π k}{P} t ) , sin ( \frac{2 π k}{P} t ) )$$

The above mathematical model/function can be implemented by the corresponding ML module. For instance, as exemplified in FIG. 1B, the ML module 114 illustrated on the right side of the figure is specifically constructed to represent the above function. For instance, the ML module 114 can comprise three layers: a FC layer, a periodic activation layer and a stack of fully connected (FC) layers. The FC layer gets an input time variable t and applies a linear function. This FC layer learns an appropriate phase-shift and period. Alternatively, the phase shift and period can be predefined. The output of the FC layer is processed by the periodic activation layer and a periodic function as described above is applied to output periodic features. These periodic features are then passed through the stack of FC layers with nonlinear activations to output the overall seasonality TS. The one or more hyperparameters characterizing the function can include the periodicity (e.g., P) of each periodic function.

According to certain embodiments, the one or more ML modules can comprise a third ML module configured to represent a component of special events (i.e., special event component) in accordance with a given model thereof. By way of example, the model of the special event component can be one or more pulse functions indicative of irregular events. The pulse function, or rectangle function, refers to a function whose value is zero outside a specific interval and whose value is a specific constant inside the interval. It is also referred to as the gate function, or window function. In some embodiments, the one or more hyperparameters characterizing the pulse functions can include a time window/interval of each pulse function.

By way of example, the pulse function can be represented by the below equation, where h(t) provides a corresponding value for a given input time t, f(t) represents a pulse function, and hₖ represents the time point of the event of interest:

$$h ( t ) = {\sum }_{k} {f}_{k} ( t - {h}_{κ} )$$

The above mathematical model/function can be implemented by the corresponding ML module. For instance, as exemplified in FIG. 1B, the ML module 116 illustrated on the right side of the figure is specifically constructed to represent the above function. For instance, the ML module 116 can comprise two layers: an embedding layer, and a stack of fully connected (FC) layers. The embedding layer takes a given input time t and outputs a vector representing all special events relevant to time point t (events whose time window overlap with t). The vector representation of non-special events is the zero vector. This representation is then passed through an FC stack to estimate the effect of relevant special events and incorporate it into the overall output. The one or more hyperparameters characterizing the function can include the time interval/window of the event (e.g., represented by f) of each pulse function.

In some embodiments, the one or more ML modules can comprise further ML modules, in addition to or in lieu of one or more of the above exemplified components, which are configured to represent other possible components of the time series data.

The one or more ML modules can be operatively connected to an output layer of the ML network, such as, e.g., a stack of fully connected (FC) layers 120, as illustrated in FIG. 1B. The FC stack can combine the output of the different components so as to provide an overall output y\hat{ }(t). Additionally, each of the one or more components can provide its own output as a partial output corresponding to a respective component, which is self-explanatory and more intuitive to the user as it is associated with the respective component, as exemplified in FIG. 1B as y\hat{ }_{explainable} (t).

As aforementioned, the ML models can be implemented as various types of machine learning models as exemplified above, and can be deemed as being comprised in the PMC 102. In one embodiment, the ML models can be implemented as deep learning neural networks (also referred to as deep neural networks, or DNNs). The general description of DNN architecture and implementation is described in detail above and thus will not be repeated here for purpose of brevity and conciseness of the description.

It is to be noted that the above described ML module structures and the mathematical models thereof are illustrated only for exemplary purposes and should not be deemed as limiting the present disclosure in any way. Other suitable structures of ML modules, as well as other possible mathematical implementations representing the components, can be used in addition to or in lieu of the above.

According to certain embodiments, the values of the one or more hyperparameters associated with each component are automatically tuned/optimized during training of the ML network, e.g., by the training module 104. Specifically, the ML network can be trained using training data including historical time series data pertaining to one or more tasks, to jointly optimize values of network parameters (e.g., the node weights and/or thresholds of the neural network) and the set of hyperparameters. All the ML modules comprised in the ML network are trained simultaneously as a whole using the one or more task data.

The ML network can be trained using different learning algorithms, such as, e.g., supervised learning, unsupervised learning, or semi-supervised learning. The prediction result can be compared with the ground truth so as to optimize the network parameters (e.g., weights and/or thresholds, etc.) as well as the hyperparameters of the ML network. The parameters can be iteratively adjusted during training to achieve an optimal set of parameter values in a trained ML network.

In some embodiments, the one or more tasks can comprise multiple tasks that are correlated to each other. This is also referred to as multi-task learning (MTL). Multi-task learning has advantages over single task learning from several aspects. By way of example, MTL can potentially reduce the required computational resources in both training and inference phases. MTL is also particularly beneficial in the low-data regime. For instance, assume there is a prediction task with limited historical data (e.g., only data from the past few months is available due to lack of historical tracking, and/or introduction of a new brand/product, etc.). However, it is known that the specific TS series is highly affected by yearly seasonality. In such cases it is not possible to model such component which is not presented in the available data. For overcoming the issue of lack of necessary historical data, the model can be simultaneously/jointly trained on the original task together with another related task(s) which has a sufficient amount of historical data. In such cases the MTL is utilized to transfer knowledge between tasks, and the model can learn a joint representation for all tasks which will contain information on the yearly seasonality component that is unavailable in the data for the original task.

Turning now to FIG. 3, there is illustrated a generalized flowchart of training the ML network in accordance with certain embodiments of the presently disclosed subject matter.

One or more tasks that are correlated to each other can be selected (302). According to certain embodiments, the selected tasks can be correlated positively (e.g., two products whose sales grow together before holidays) or negatively (e.g., two products that compete with each other with respect to market share). In some cases, the tasks can be selected in a hierarchical manner, such as, e.g., a hierarchy of time-series pertaining to hierarchical products (e.g., different product groups such as milk products and cheese). In such cases, each level/layer within the hierarchy can benefit from the correlated hierarchical tasks between and across the layers.

In some embodiments, the selection can be done using unsupervised learning techniques. By way of example, each task can be characterized by a set of features/attributes thereof which can be represented by a multi-dimensional feature vector. Time series that behave similarly (in terms of seasonality, special events, etc.) are likely to share similar representation in the multi-dimensional feature space, such as, e.g., similar low dimensional representation. Therefore, tasks that share similar feature representation in the feature space can be grouped together as correlated tasks.

By way of example, the grouping can be performed by soft clustering. Soft clustering, also referred to as fuzzy clustering, is a form of clustering in which each data point can belong to more than one cluster, as compared to non-fuzzy clustering (also known as hard clustering), where data is divided into distinct clusters. Clusters can be identified using similarity measures such as, e.g., distance, connectivity, and intensity, etc. between the multi-dimensional representation of the task data. Different similarity measures may be chosen based on different task data.

Historical time series data pertaining to the selected correlated tasks can be obtained (304) to generate training data for training the ML network. Once the training data is ready, the ML network can be trained (306) using the training data pertaining to multiple tasks, to jointly optimize values of the network parameters and the set of hyperparameters of the ML network as described above. Specifically, the network is trained simultaneously using the multiple task data, which can be considered as multi-channel time series data. At a give time point, the input to the network can be multiple values from the multiple TSs. In case where one channel is missing data for certain time points, the network can still exploit the amount of data on another channel for such time points. Therefore, the ML network, once trained, can make predictions for both channels, whose performance, especially with respect to the channel with missing data, can be significantly improved.

Turning now to FIG. 6, there is illustrated an example of multi-task learning in accordance with certain embodiments of the presently disclosed subject matter.

Assume there are two correlated tasks, task 1 for prediction of sales of milk product A in general, and task 2 for prediction of sales of milk product B. For task 1 there is one year's historical sales data available (note not all the time ranges are illustrated due to limitation of the figure), but for task 2 there is only three months' historical sales data available. In such cases, it is impossible to model the yearly seasonality of task 2 by using the single task learning approach. Instead, multitask learning can utilize data from two datasets to share information among tasks. The two tasks can be trained together, thus making it possible to learn yearly seasonality and holiday effects for task 2. As illustrated, the vertical dashed line 602 at the time point of 2017-10 indicates the end of the training phase of the two tasks. Before the line 602, the dashed TS graph 604 represents the historical sales data used to train the ML network on the tasks. After line 602, the concrete TS graph 606 represents the sales prediction of the two tasks from the timepoint of 2017-10 onwards.

It is to be noted that the stage after line 602 as illustrated is actually a validation stage where the trained network is tested using a validation dataset. Therefore, in addition to the concrete TS graph 606 which represents the prediction TS data generated using the trained network, there is also illustrated a dashed graph 608 which represents the actual TS data for this time period. The two graphs 606 and 608 can be compared and the prediction performance of the trained network can be evaluated. As illustrated in the present example, the two graphs appear to share similar behaviors.

Continuing with the description of FIG. 2, once the ML network is trained, during inference, in response to a user's request of TS prediction for a given time period, the trained ML network 106 can be used (204) (e.g., by the TS prediction module 108) to perform TS prediction, giving rise to a prediction result comprising an overall predicted TS (also referred to herein as overall prediction TS or overall TS), as an overall output of the output layer, and one or more decomposed predicted TS (also referred to herein as decomposed prediction TS or decomposed TS) of the overall TS, as output of the one or more ML modules, each decomposed TS representative of a partial prediction of the given time period corresponding to a respective component represented by the corresponding ML module.

As illustrated in FIG. 1B, the prediction result of the ML network 106 can include an overall predicted TS y\hat{ }(t), as the output of the output layer (e.g., the FC stack 120). In addition, the prediction result can also include the decomposed TSs y\hat{ }_{explainable} (t) as respective outputs of the ML modules 112, 114, 116 and 118. Each of the decomposed TSs y\hat{ }_{explainable} is a partial prediction output corresponding to a respective component represented by the corresponding ML module. The overall GC 10 output y\hat{ }(t) can be generated by combining the output of the different ML modules.

The ability of providing output of the decomposed TSs corresponding to multiple components enables the prediction result to be highly interpretable to the user, who can understand the underlying indication of the prediction, and can use the prediction in planning and decision-making, thus improving user's trust in the model and increasing the usability of the predictions.

By way of example, assume in the decomposed TS corresponding to the seasonality component, there is illustration of a monthly seasonality that the amount of sales is lower at the end of each month. This phenomenon might not be so significant that a human eye would notice it in the overall TS, especially when there are other components that affect the time series. However, by automatically generating and illustrating the decomposed TSs to the domain experts, it helps the domain experts to have new insights into the behaviors of the TS data and/or the reasoning of such behaviors. For instance, the domain experts may recognize that it could be because at the end of every month the salary or credit of the customers is already consumed. In addition, it can also provide confidence to the domain expert as the decomposed TSs of different components are clear and correlate to his understanding of how each component may affect the prediction.

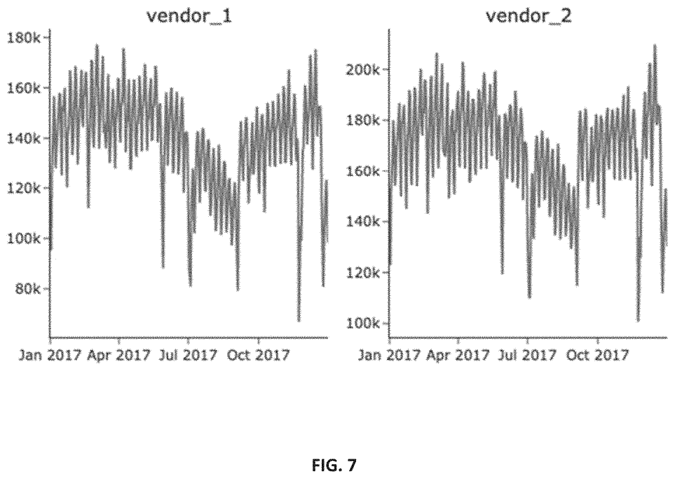

FIG. 7 illustrates examples of an overall predicted time series in accordance with certain embodiments of the presently disclosed subject matter. As shown, two prediction TSs are generated respectively for two vendors for a given time period of January 2017 to December 2017. Specifically, the present example relates to TS prediction of taxi rides (e.g., the number of daily rides for specific taxi vendors 1 and 2).

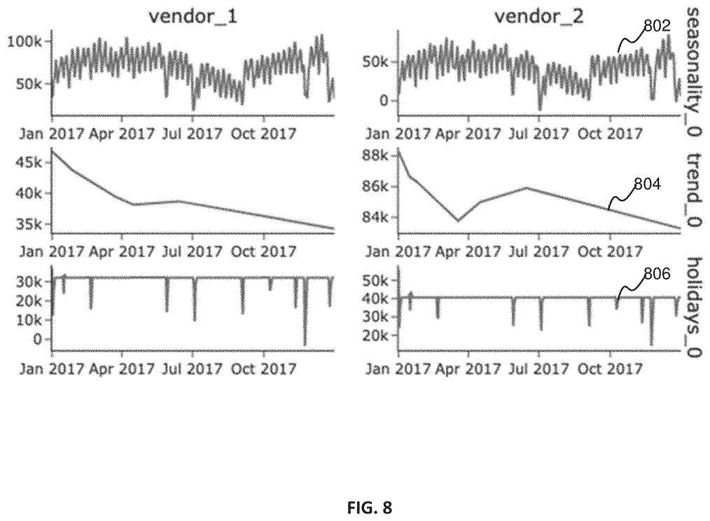

FIG. 8 illustrates an example of decomposed TSs of the overall TS of FIG. 7 in accordance with certain embodiments of the presently disclosed subject matter. As shown, there are three decomposed TSs corresponding to the three components of seasonality, trend and holidays (events). Specifically, the decomposed TS 802 represents seasonal changes with certain periodicity (in this example with a periodicity of yearly seasonality). The TS 802 can reflect an aggregation of multiple different periodic functions. The decomposed TS 804 represents changes of trend, which are reflected in the TS 804 as changing time points (e.g., the time points of approximately 2017-03 and 2017-06 for vendor 2) between neighboring pieces of the piecewise linear function, and the gradient of each piece of the linear function. The decomposed TS 806 represents irregular events which are usually non-periodic, such as, e.g., holidays, promotions, etc., which are reflected in the TS 806 as pulse functions representing different events and the time intervals thereof. As illustrated, the effect of several events on the number of daily rides is negative, which is mainly due to the holiday period during which less people take taxis.

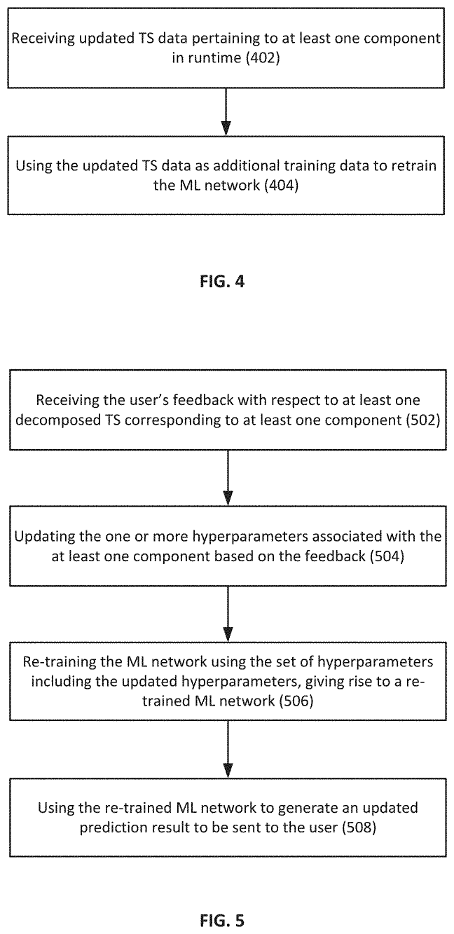

Turning now to FIG. 4, there is illustrated a generalized flowchart of a runtime retraining process of the ML network based on updated TS data in accordance with certain embodiments of the presently disclosed subject matter.

In some cases, the historical TS data that is available at the training phase can be limited, e.g., with respect to at least certain components. In such cases, the ML network can be initially trained in the training phase using the available training data In runtime, upon receiving (402) updated TS data pertaining to at least one component, the updated TS data can be used as additional training data to retrain (404) the ML network, before using the ML network to perform TS prediction. This can be especially useful when the up-to-date TS data is only available at customer's site (i.e., a production environment) while the ML network is initially trained in a development environment where the amount of training data is limited and not up-to-date. In such cases, the above-described re-training step can be performed in runtime and before the actual inference using the ML network.

According to certain embodiments, the prediction result can further comprise the values of the set of hyperparameters of the trained ML network (i.e., the optimized and tuned values of the hyperparameters). The hyperparameter values can be provided to the domain experts (and/or the users) to help them understand the behaviors of the TS with respect to the parameter values. In some cases, the domain experts and/or the users, upon reviewing the hyperparameter values, may have the option to provide feedback, e.g., by adjusting the values of some of the hyperparameters, and/or adding or removing certain hyperparameters based on their domain knowledge and experience. The ML network with the manually adjusted hyperparameters can be re-trained and used to perform an updated TS prediction.

Additionally or alternatively, in some embodiments, upon reviewing the prediction result (including the overall TS and the decomposed TSs), the user (and/or the domain expert) can provide feedback with respect to at least one decomposed TS corresponding to at least one component, and the ML network can be re-trained based on the user feedback.

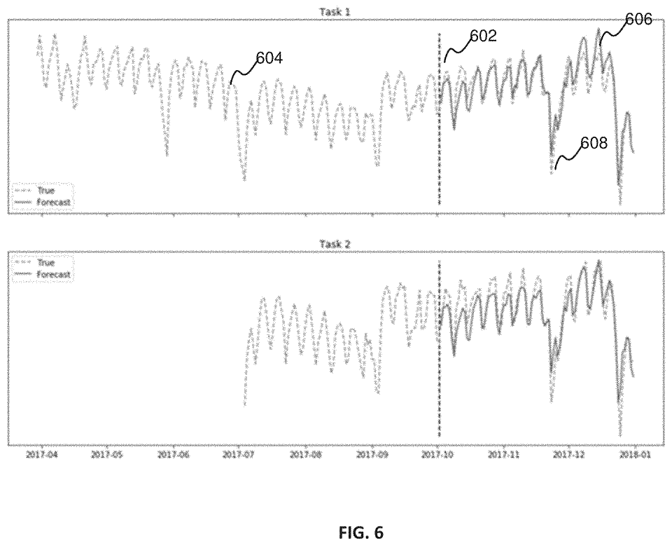

Turning now to FIG. 5, there is illustrated a generalized flowchart of a runtime retraining process of the ML network based on user feedback in accordance with certain embodiments of the presently disclosed subject matter.

Upon receiving (502) the user's feedback with respect to the at least one decomposed TS, the one or more hyperparameters associated with the at least one component can be updated (504) based on the user feedback. For example, upon reviewing the decomposed TS related to events, a user may notice that a specific event is missing, or the time window thereof is not correct. Accordingly, the hyperparameters related to this specific component can be updated to reflect such feedback. In another example, a user may notice that a change in trend may necessarily cause a corresponding event in the event component, which can be reflected by updating the hyperparameters of this component accordingly. The ML network can be re-trained (506) using the set of hyperparameters including the updated hyperparameters, giving rise to a re-trained ML network. The re-trained ML network can be used (508) to generate an updated prediction result to be sent to the user.

According to further embodiments, the user can provide feedback on the prediction result indicating that one or more additional hyperparameters should be included in the ML network. In some cases, the additional hyperparameters may be associated with at least one existing component, while in some other cases, the additional hyperparameters may be associated with at least one additional component which is not yet represented in the ML network. In the former case, the at least one ML module representing the at least one component can be modified to reflect the additional hyperparameters. For instance, the ML module can be modified to reflect additional dimensions of the TS data, and/or to include a new/updated mathematical model and/or new structure of the ML module, etc. In the latter case, at least an additional ML module can be added to the ML network to represent the at least one additional component, where the additional ML module reflects the additional hyperparameters. The ML network can be retrained using the set of hyperparameters which now includes the additional hyperparameters, giving rise to a re-trained ML network. The re-trained ML network can be used to generate an updated prediction result to be sent to the user.

It is to be noted that the examples referred to herein, such as, e.g., the listed components, the ML modules, the mathematical models and the prediction tasks etc. are described herein for illustrative and exemplified purposes, and should not be regarded as limiting the present disclosure in any way. Other suitable alternatives can be used in addition to, or in lieu of the above.

It is to be noted that the TS prediction system described above can be used for prediction with respect to various real-life applications, such as, e.g., energy consumption prediction in manufacture, weather/temperature prediction, crops yield, etc., in addition to the examples illustrated above, and the present disclosure is not limited by a specific application thereof.

Among advantages of certain embodiments of the TS prediction process as described herein is the automation of the selection of hyperparameter values of the ML network, which not only saves computational time and resources, but also results in more precise values for these parameters.

This is enabled by the specific ML network design and structure which is constructed to model the components so as to be able to incorporate the hyperparameters as an inherent part of the network, thus these hyperparameters can be automatically optimized/tuned during the training of the entire network.

The computerized prediction system implemented as such has an improved internal functionality with respect to, by way of example, higher processing efficiency, better computation load balancing, etc., by splitting of the prediction processing tasks to different computing models of the ML network, thereby accelerating and optimizing the training and the inference processes.

In some cases, the automation can also enable the system to have a significantly higher number of hyperparameters as compared to when the hyperparameters were manually tuned. The proposed TS prediction system has improved forecasting performance with higher accuracy and lower error rate.

The technical advantages can be further enhanced by the ability of providing output of the decomposed TSs corresponding to multiple components, which enables the prediction result to be highly interpretable to the user, who can understand the underlying indication of the prediction and can use the prediction in planning and decision-making, thus improving user's trust in the model and increasing the usability of the predictions.

It is to be understood that the present disclosure is not limited in its application to the details set forth in the description contained herein or illustrated in the drawings.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A computerized method of time series (TS) prediction, the method performed by a processor and memory circuitry (PMC), the method comprising:
providing a machine learning (ML) network trained to perform TS prediction with respect to one or more components each representing an underlying pattern indicative of a specific type of behavior of a time series, wherein the ML network is configured with a set of hyperparameters including one or more hyperparameters associated with each component, the ML network comprising one or more ML modules operatively connected to an output layer, wherein each ML module is configured to represent a respective component in accordance with a given model thereof, the given model characterized by the one or more hyperparameters associated with the respective component, wherein values of the one or more hyperparameters associated with each component are automatically optimized during training of the ML network; and
in response to a user's request for TS prediction for a given time period, using the trained ML network to perform TS prediction, giving rise to a prediction result comprising an overall predicted TS, as an overall output of the output layer, and one or more decomposed TS of the overall predicted TS, as output of the one or more ML modules, each decomposed TS representative of a partial prediction of the given time period corresponding to a respective component represented by the corresponding ML module.

2. The computerized method according to claim 1, wherein the one or more components are selected from a group comprising: trend, seasonality, events, autoregressive, and external regressor.

3. The computerized method according to claim 1, wherein the one or more ML modules comprise a first ML module configured to represent a component of trend in accordance with a spline function indicative of changes of trend.

4. The computerized method according to claim 3, wherein the one or more hyperparameters characterizing the spline function include changing time points between neighboring pieces of the spline function, and a gradient of each piece of the spline function.

5. The computerized method according to claim 1, wherein the one or more ML modules comprise a second ML module configured to represent a component of seasonality in accordance with one or more periodic functions indicative of seasonal changes.

6. The computerized method according to claim 5, wherein the one or more hyperparameters characterizing the periodic functions include the periodicity of each periodic function.

7. The computerized method according to claim 1, wherein the one or more ML modules comprise a third ML module configured to represent special events in accordance with one or more pulse functions indicative of irregular events.

8. The computerized method according to claim 7, wherein the one or more hyperparameters characterizing the pulse functions include a time window of each pulse function.

9. The computerized method according to claim 1, wherein the ML network is trained using training data including historical TS data pertaining to one or more tasks, to jointly optimize values of network parameters and the set of hyperparameters.

10. The computerized method according to claim 9, wherein the one or more tasks comprise multiple tasks that are correlated to each other, and the multiple tasks are selected using unsupervised learning by grouping tasks that share similar feature representation in a multi-dimensional feature space.

11. The computerized method according to claim 1, wherein the prediction result further comprises the values of the set of hyperparameters of the trained ML network.

12. The computerized method according to claim 1, further comprising receiving updated TS data pertaining to at least one component in runtime, and using the updated TS data as additional training data to retrain the ML network, before using the ML network to perform TS prediction.

13. The computerized method according to claim 1, further comprising, upon receiving the user's feedback with respect to at least one decomposed TS corresponding to at least one component, updating the one or more hyperparameters associated with the at least one component based on the feedback; re-training the ML network using the set of hyperparameters including the updated hyperparameters, giving rise to a re-trained ML network; and using the re-trained ML network to generate an updated prediction result to be sent to the user.

14. The computerized method according to claim 1, further comprising, upon receiving the user's feedback on the prediction result indicating one or more additional hyperparameters to be associated with at least one existing component and/or associated with at least one additional component, modifying at least one ML module representing the at least one component or adding at least an additional ML module representing the at least one additional component to reflect the additional hyperparameters; re-training the ML network using the set of hyperparameters including the additional hyperparameters, giving rise to a re-trained ML network, and using the re-trained ML network to generate an updated prediction result to be sent to the user.

15. The computerized method according to claim 1, wherein each of the one or more ML modules is implemented in a form selected from a group comprising: support vector machine, decision tree, neural network, genetic model, or combination thereof.

16. A computerized system of time series (TS) prediction, the system comprising a processor and memory circuitry (PMC) configured to:
provide a machine learning (ML) network trained to perform TS prediction with respect to one or more components each representing an underlying pattern indicative of a specific type of behavior of a time series, wherein the ML network is configured with a set of hyperparameters including one or more hyperparameters associated with each component, the ML network comprising one or more ML modules operatively connected to an output layer, wherein each ML module is configured to represent a respective component in accordance with a given model thereof, the given model characterized by the one or more hyperparameters associated with the respective component, wherein values of the one or more hyperparameters associated with each component are automatically optimized during training of the ML network; and
in response to a user's request for TS prediction for a given time period, use the trained ML network to perform TS prediction, giving rise to a prediction result comprising an overall predicted TS, as an overall output of the output layer, and one or more decomposed TS of the overall predicted TS, as output of the one or more ML modules, each decomposed TS representative of a partial prediction of the given time period corresponding to a respective component represented by the corresponding ML module.

17. The computerized system according to claim 16, wherein the one or more ML modules comprise a first ML module configured to represent a component of trend in accordance with a spline function indicative of changes of trend.

18. The computerized system according to claim 17, wherein the one or more hyperparameters characterizing the spline function include changing time points between neighboring pieces of the spline function, and a gradient of each piece of the spline function.

19. The computerized system according to claim 16, wherein the one or more ML modules comprise a second ML module configured to represent a component of seasonality in accordance with one or more periodic functions indicative of seasonal changes.

20. The computerized system according to claim 19, wherein the one or more hyperparameters characterizing the periodic functions include the periodicity of each periodic function.

21. The computerized system according to claim 16, wherein the one or more ML modules comprise a third ML module configured to represent special events in accordance with one or more pulse functions indicative of irregular events.

22. The computerized system according to claim 21, wherein the one or more hyperparameters characterizing the pulse functions include a time window of each pulse function.

23. The computerized system according to claim 16, wherein the ML network is trained using training data including historical TS data pertaining to one or more tasks, to jointly optimize values of network parameters and the set of hyperparameters.

24. The computerized system according to claim 23, wherein the one or more tasks comprise multiple tasks that are correlated to each other, and the multiple tasks are selected using unsupervised learning by grouping tasks that share similar feature representation in a multi-dimensional feature space.

25. The computerized system according to claim 16, wherein the prediction result further comprises the values of the set of hyperparameters of the trained ML network.

26. The computerized system according to claim 16, wherein the PMC is further configured to, upon receiving the user's feedback with respect to at least one decomposed TS corresponding to at least one component, update the one or more hyperparameters associated with the at least one component based on the feedback; re-train the ML network using the set of hyperparameters including the updated hyperparameters, giving rise to a re-trained ML network; and use the re-trained ML network to generate an updated prediction result to be sent to the user.

27. The computerized system according to claim 16, wherein the PMC is further configured to, upon receiving the user's feedback on the prediction result indicating one or more additional hyperparameters to be associated with at least one existing component and/or associated with at least one additional component, modify at least one ML module representing the at least one component or add at least an additional ML module representing the at least one additional component to reflect the additional hyperparameters; re-train the ML network using the set of hyperparameters including the additional hyperparameters, giving rise to a re-trained ML network, and use the re-trained ML network to generate an updated prediction result to be sent to the user.

28. A non-transitory computer readable storage medium tangibly embodying a program of instructions that, when executed by a computer, cause the computer to perform a method of time series (TS) prediction, the method comprising:
providing a machine learning (ML) network trained to perform TS prediction with respect to one or more components each representing an underlying pattern indicative of a specific type of behavior of a time series, wherein the ML network is configured with a set of hyperparameters including one or more hyperparameters associated with each component, the ML network comprising one or more ML modules operatively connected to an output layer, wherein each ML module is configured to represent a respective component in accordance with a given model thereof, the given model characterized by the one or more hyperparameters associated with the respective component, wherein values of the one or more hyperparameters associated with each component are automatically optimized during training of the ML network; and
in response to a user's request for TS prediction for a given time period, using the trained ML network to perform TS prediction, giving rise to a prediction result comprising an overall predicted TS, as an overall output of the output layer, and one or more decomposed TS of the overall predicted TS, as output of the one or more ML modules, each decomposed TS representative of a partial prediction of the given time period corresponding to a respective component represented by the corresponding ML module.
